(19) United States
(12) Patent Application Publication
(10) Pub. No.: US 2025/0242601 A1
(43) Pub. Date: Jul. 31, 2025

(54) LANDING POSITION DEVIATION AMOUNT DETECTION METHOD, PRINTING APPARATUS, AND NON-TRANSITORY COMPUTER-READABLE RECORDING MEDIUM RECORDING LANDING POSITION DEVIATION AMOUNT DETECTION PROGRAM

(71) Applicant: SCREEN Holdings Co., Ltd., Kyoto (JP)

(72) Inventor: Kenichi YOKOUCHI, Kyoto-shi, Kyoto (JP)

(21) Appl. No.: 18/983,892

(22) Filed: Dec. 17, 2024

(30) Foreign Application Priority Data
Jan. 31, 2024 (JP) 2024-013200

(51) Int. Cl. B41J 2/21; G06T 7/00; G06T 7/73

(52) U.S. Cl. CPC B41J 2/2142; B41J 2/2135; G06T 7/001; G06T 7/73; G06T 2207/20021; G06T 2207/30144

(57) ABSTRACT

A provisional landing position at which ink ejected from a nozzle is assumed to land on printing paper is calculated, and an actual landing position at which ink ejected from the nozzle actually lands on the printing paper is calculated. A difference between the actual landing position and the provisional landing position is obtained as a first differential amount, and a moving average of the first differential amounts is obtained. A difference between the moving average of the first differential amounts and the first differential amount is obtained as a second differential amount. An average of the second differential amounts of the nozzles associated with a focused nozzle in advance is obtained as an average second differential amount corresponding to the focused nozzle. A difference between the second differential amount and the average second differential amount is obtained as a landing position deviation amount.

### BACKGROUND OF THE INVENTION

### Field of the Invention

The present invention relates to a printing apparatus including an ink ejection head (print head) provided with a large number of nozzles that eject ink, and more particularly to a technique for detecting a nozzle in an ejection defect state (hereinafter, the nozzle in the ejection defect state is referred to as an “ejection defect nozzle”) in such a printing apparatus.

### Description of Related Art

An inkjet printing apparatus that performs printing by ejecting ink onto a print medium such as printing paper is widely known. In the inkjet printing apparatus, drying of the ink due to evaporation of a solvent in the vicinity of a nozzle, mixing of air bubbles into the nozzle, adhesion of dust to the nozzle, and the like may occur. That is, ejection defects of the nozzle may occur. When the ejection defects occur, missing of the dot corresponding to the ejection defect nozzle, that is, missing of the dot occurs in a print image. In this case, for example, an operation (cleaning or flushing) for recovering a function of the ejection defect nozzle and an alternative droplet ejection in which ink droplets to be ejected by the ejection defect nozzle are ejected by another nozzle are performed.

The ejection defects of a nozzle can be roughly classified into three types, which will be described with reference to FIGS. 32 to 34. Note that FIGS. 32 to 34 illustrate a part of a print image obtained by printing a stepwise regular pattern (test pattern), and a black shaded portion is a portion where ink is applied. In a dotted line portion denoted by reference sign 91 in FIG. 32, no ink is applied to a portion where ink is to be applied. Hereinafter, such ejection defects are referred to as “non-ejection”. In a dotted line portion denoted by reference sign 92 in FIG. 33, a shape of a portion where the ink is applied is different from the original shape. Hereinafter, such ejection defects are referred to as “shape defects”. The shape defects also include ejection defects in a blurred state due to insufficient density and ejection defects in a state in which a portion where ink is applied spreads in a paper width direction (main scanning direction) (direction orthogonal to a conveyance direction of printing paper). In a dotted line portion denoted by reference sign 93 in FIG. 34, ink is applied to a portion deviated in the paper width direction from the portion where the ink is originally to be applied. Hereinafter, such ejection defects are referred to as “landing position deviation”.

In a conventional inkjet printing apparatus, ejection defects as described above are detected by, for example, a technique by numerical analysis or a technique using machine learning based on a captured image (captured image data) obtained by imaging an image on which a predetermined test pattern (typically, the stepwise regular pattern described above) is printed with an imaging device. Note that detection of the ejection defects may be performed by visual inspection of a print image of a predetermined test pattern.

By the way, in a case where the landing position deviation is detected by the technique by numerical analysis, it is necessary to obtain a distance (hereinafter, it is referred to as a “landing position deviation amount”) between a position where the ink should originally land on the printing paper (hereinafter, it is referred to as a “landing reference position”) and a position where the ink actually lands on the printing paper on the basis of the captured image. In this regard, Japanese Laid-Open Patent Publication No. 2011-194734 describes obtaining a landing reference position corresponding to each nozzle by calculating a moving average on the basis of a captured image, and determining whether or not a nozzle to be determined is an ejection defect nozzle on the basis of a difference between the obtained landing reference position and an actual landing position of ink. Regarding this, for example, as illustrated in FIG. 35, it is assumed that a captured image including five linear patterns 102a to 102e corresponding to five nozzles is obtained. In this case, assuming that the position of the linear pattern 102a is P1+e1, the position of the linear pattern 102b is P2+e2, the position of the linear pattern 102c is P3+e3, the position of the linear pattern 102d is P4+e4, and the position of the linear pattern 102e is P5+e5, the landing reference position (landing reference position corresponding to a nozzle that formed the linear pattern 102c by ejecting ink) P3s corresponding to the linear pattern 102c is obtained by the following formula.

$$\begin{matrix}P 3 s = ( P 1 + e 1 + P 2 + e 2 + P 4 + e 4 + P 5 + e 5 ) / 4 \\ = ( P 1 + P 2 + P 4 + P 5 ) / 4 + ( e 1 + e 2 + e 4 + e 5 ) / 4\end{matrix}$$

Then, a difference between the landing reference position obtained by the above formula and the actual landing position of the ink is obtained, and whether or not the nozzle that formed the linear pattern 102c causes the landing position deviation is determined based on the difference.

However, according to the technique using the moving average, it is conceivable that the landing position deviation amount cannot be obtained with sufficient accuracy. That is, it is conceivable that the landing position deviation, which is one of the types of the ejection defects of the nozzle, cannot be detected with sufficient accuracy. This will be described below.

When printing is performed on printing paper by the inkjet printing apparatus, the printing paper being conveyed may expand and contract. The expansion and contraction of the printing paper may occur in both the conveyance direction of the printing paper and the paper width direction. When the printing paper expands and contracts in the paper width direction, a plurality of linear patterns is not actually printed at equal intervals in the paper width direction on the printing paper even if the ink is ejected from a plurality of nozzles so that the plurality of linear patterns is printed at equal intervals in the paper width direction. Since the printing paper has a portion extending in the paper width direction and a portion contracting in the paper width direction, if the number of data used in obtaining a moving average is increased, this makes it more susceptible to an error caused by the expansion and contraction of the printing paper, and a considerable amount of difference may occur between the landing reference position and the actual landing position of the ink even if the ink is normally ejected from the nozzle. That is, the landing position deviation amount may not be obtained correctly. On the other hand, when the number of data used in obtaining the moving average is reduced, the degree of influence of the data of the ejection defect nozzle on a calculation result of the moving average increases in a case where the data of the ejection defect nozzle is included in the used data. Also in this case, the landing position deviation amount cannot be obtained correctly. Note that the landing position deviation amount may not be correctly obtained due to the influence of an error generated when the imaging device images a print image of the test pattern. As described above, according to the conventional technique, the landing position deviation amount cannot be detected with sufficient accuracy.

### SUMMARY OF THE INVENTION

Therefore, an object of the present invention is to enable accurate detection of a size of a landing position deviation (landing position deviation amount), which is one type of ejection defects of a nozzle, regarding an inkjet printing apparatus.

One aspect of the present invention is directed to a landing position deviation amount detection method of detecting a landing position deviation amount of ink in a printing apparatus including a plurality of nozzles configured to eject ink onto a print medium conveyed in a first direction, the landing position deviation amount detection method including:
printing, by the printing apparatus, an inspection chart including M-stage inspection patterns corresponding one-to-one to M groups obtained by grouping the plurality of nozzles, where M is an integer of 2 or more;
imaging the inspection chart;
obtaining a reference position with taking each of the plurality of nozzles as a focused nozzle, the reference position being a position at which ink ejected from the focused nozzle is assumed to land on the print medium;
obtaining an actual landing position that is a position at which ink ejected from the focused nozzle is actually landed on the print medium, based on a captured image obtained in the imaging the inspection chart;
obtaining a first differential amount that is a difference between the actual landing position and the reference position;
obtaining a moving average that is an average of the first differential amounts of two or more nozzles that belong to a group same as the focused nozzle and are to land ink at a position within a predetermined distance in a second direction orthogonal to the first direction from a position at which the focused nozzle is to land ink;
obtaining a second differential amount that is a difference between the difference between the actual landing position and the reference position and the moving average;
obtaining an average second differential amount that is an average of the second differential amounts of two or more nozzles that belong to a group different from the focused nozzle and are associated with the focused nozzle in advance; and
obtaining a landing position deviation amount that is a difference between the second differential amount and the average second differential amount.

According to such a configuration, after the difference between the “difference (first differential amount) between the actual landing position and the reference position” and the “moving average of the differences (first differential amounts) between the actual landing position and the reference position” is obtained as the second differential amount, the average of the second differential amounts of the nozzles belonging to the group different from the focused nozzle is obtained as the average second differential amount corresponding to the focused nozzle. Then, the difference between the second differential amount and the average second differential amount is obtained as the landing position deviation amount. Here, the second differential amount is affected by the landing position deviation and is affected by the expansion and contraction of the print medium. Furthermore, the average second differential amount is mainly affected by the expansion and contraction of the print medium. Therefore, by adopting the difference between the second differential amount and the average second differential amount as the landing position deviation amount, even if the number of data used in obtaining the moving average is increased, the influence of the expansion and contraction of the print medium with respect to the landing position deviation amount obtained for each nozzle can be made smaller than before. As above, regarding the printing apparatus including the plurality of nozzles that ejects ink, it is possible to accurately detect the size of the landing position deviation (landing position deviation amount), which is one type of the ejection defects of the nozzle. Furthermore, since the landing position deviation that cannot be detected by the conventional technique can be detected, wasteful consumption of the print medium and ink due to reprinting is suppressed. Thus, it is possible to contribute to the achievement of the SDGs (sustainable development goals).

Another aspect of the present invention is directed to a printing apparatus including:
a plurality of nozzles configured to eject ink onto a print medium conveyed in a first direction;
an imaging device configured to image a print image; and
a controller configured to control ejection of ink from the plurality of nozzles and imaging of the print image by the imaging device,
the controller executing:
   an inspection chart printing process of controlling the ejection of ink from the plurality of nozzles so that an inspection chart including M-stage inspection patterns corresponding one-to-one to M groups obtained by grouping the plurality of nozzles is printed, where M is an integer of 2 or more;
   an inspection chart imaging process of causing the imaging device to image the inspection chart printed by the inspection chart printing process;
   a reference position calculation process of obtaining, with taking each of the plurality of nozzles as a focused nozzle, a position at which ink ejected from the focused nozzle is assumed to land on the print medium as a reference position;
   an actual landing position calculation process of obtaining a position at which ink ejected from the focused nozzle is actually landed on the print medium as an actual landing position, based on a captured image obtained by the inspection chart imaging process;
   a first differential amount calculation process of obtaining a difference between the actual landing position and the reference position as a first differential amount;
   a moving average calculation process of obtaining an average of the first differential amounts of two or more nozzles that belong to a group same as the focused nozzle and are to land ink at a position within a predetermined distance in a second direction orthogonal to the first direction from a position at which the focused nozzle is to land ink, as a moving average corresponding to the focused nozzle;
   a second differential amount calculation process of obtaining a difference between the difference between the actual landing position and the reference position and the moving average, as a second differential amount;
   an average second differential amount calculation process of obtaining an average of the second differential amounts of two or more nozzles that belong to a group different from the focused nozzle and are associated with the focused nozzle in advance, as an average second differential amount corresponding to the focused nozzle; and
   a landing position deviation amount calculation process of obtaining a difference between the second differential amount and the average second differential amount, as a landing position deviation amount.

Still another aspect of the present invention is directed to a non-transitory computer-readable recording medium recording a landing position deviation amount detection program for detecting a landing position deviation amount of ink in a printing apparatus including a plurality of nozzles configured to eject ink onto a print medium conveyed in a first direction and an imaging device configured to image a print image,
the landing position deviation amount detection program causing a computer included in the printing apparatus to execute:
   controlling ejection of ink from the plurality of nozzles so that an inspection chart including M-stage inspection patterns corresponding one-to-one to M groups obtained by grouping the plurality of nozzles is printed, where M is an integer of 2 or more;
   causing the imaging device to image the inspection chart so as to obtain a captured image of the inspection chart;
   obtaining a reference position with taking each of the plurality of nozzles as a focused nozzle, the reference position being a position at which ink ejected from the focused nozzle is assumed to land on the print medium;
   obtaining an actual landing position that is a position at which ink ejected from the focused nozzle is actually landed on the print medium, based on the captured image;
   obtaining a first differential amount that is a difference between the actual landing position and the reference position;
   obtaining a moving average that is an average of the first differential amounts of two or more nozzles that belong to a group same as the focused nozzle and are to land ink at a position within a predetermined distance in a second direction orthogonal to the first direction from a position at which the focused nozzle is to land ink;
   obtaining a second differential amount that is a difference between the difference between the actual landing position and the reference position and the moving average;
   obtaining an average second differential amount that is an average of the second differential amounts of two or more nozzles that belong to a group different from the focused nozzle and are associated with the focused nozzle in advance; and
   obtaining a landing position deviation amount that is a difference between the second differential amount and the average second differential amount.

These and other objects, features, modes, and advantageous effects of the present invention will become more apparent from the following detailed description of the present invention with reference to the accompanying drawings.

### BRIEF DESCRIPTION OF THE DRAWINGS

FIG. 1 is an overall configuration diagram of a printing system according to an embodiment of the present invention;

FIG. 2 is a schematic diagram illustrating a configuration example of an inkjet printing apparatus in the embodiment;

FIG. 3 is a plan view illustrating a configuration example of a recording unit in the embodiment;

FIG. 4 is a diagram for explaining an arrangement of nozzles in an ink ejection head in the embodiment;

FIG. 5 is a block diagram illustrating a hardware configuration of a print control device in the embodiment;

FIG. 6 is a block diagram illustrating a schematic functional configuration of a controller realized by executing a print control program in the print control device in the embodiment;

FIG. 7 is a diagram schematically illustrating an example of an inspection chart used in the embodiment;

FIG. 8 is a diagram for explaining grouping of nozzles in the embodiment;

FIG. 9 is a flowchart illustrating a schematic procedure of landing position deviation detection in the embodiment;

FIG. 10 is a flowchart illustrating a procedure for calculating a landing position deviation amount in a comparative example;

FIG. 11 is an example of a graph illustrating first differential amounts obtained on the basis of a captured image of an inspection pattern of a certain stage;

FIG. 12 is a diagram for explaining calculation of a moving average of the first differential amount;

FIG. 13 is an example of a graph illustrating moving averages of the first differential amounts;

FIG. 14 is an example of a graph illustrating second differential amounts;

FIG. 15 is a diagram for explaining a case where data corresponding to each of 20 nozzles is used when the moving average is obtained;

FIG. 16 is a diagram for explaining a case where data corresponding to each of four nozzles is used when the moving average is obtained;

FIG. 17 is a block diagram illustrating a detailed configuration of an ejection defect detection unit in the embodiment;

FIG. 18 is a flowchart illustrating a procedure for calculating the landing position deviation amount in the embodiment;

FIG. 19 is a diagram for explaining calculation of a provisional landing position in the embodiment;

FIG. 20 is a flowchart illustrating a procedure for obtaining an actual landing position in the embodiment;

FIG. 21 is a diagram for explaining division of a captured image in the embodiment;

FIG. 22 is a diagram for explaining trimming in dividing a captured image in the embodiment;

FIG. 23 is a diagram for explaining calculation of an average value of data of a plurality of pixels for each divided image in the embodiment;

FIG. 24 is a diagram for explaining that a second differential amount for each nozzle is obtained for each stage of the inspection pattern in the embodiment;

FIG. 25 is a diagram for explaining calculation of an average second differential amount in the embodiment;

FIG. 26 is an example of a graph illustrating average second differential amounts in the embodiment.

FIG. 27 is a diagram for explaining effects in the embodiment;

FIG. 28 is a block diagram illustrating a detailed configuration of an ejection defect detection unit in a first modification of the embodiment;

FIG. 29 is a flowchart illustrating a procedure for calculating a landing position deviation amount in the first modification of the embodiment;

FIG. 30 is a diagram for explaining calculation of an average second differential amount in a second modification of the embodiment;

FIG. 31 is a diagram for explaining calculation of the average second differential amount in the second modification of the embodiment;

FIG. 32 is a diagram for explaining non-ejection;

FIG. 33 is a diagram for explaining shape defects;

FIG. 34 is a diagram for explaining a landing position deviation; and

FIG. 35 is a diagram for explaining a technique disclosed in Japanese Laid-Open Patent Publication No. 2011-194734.

### DETAILED DESCRIPTION OF PREFERRED EMBODIMENTS

Hereinafter, an embodiment of the present invention will be described with reference to the accompanying drawings.

### 1. Overall Configuration of Printing System

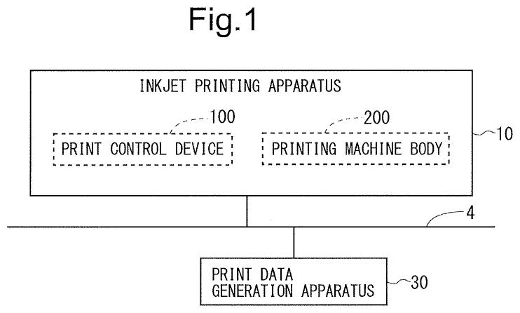

FIG. 1 is an overall configuration diagram of a printing system according to an embodiment of the present invention. The printing system includes an inkjet printing apparatus 10 and a print data generation apparatus 30. The inkjet printing apparatus 10 and the print data generation apparatus 30 are connected to each other by a LAN 4. The print data generation apparatus 30 generates print data by performing a rasterization process or the like on submitted data such as a PDF file. This print data is data not subjected to a halftone process, and the halftone process is performed by a print control device 100 in the inkjet printing apparatus 10 as described later. The print data generated by the print data generation apparatus 30 is transmitted to the inkjet printing apparatus 10 via the LAN 4. The inkjet printing apparatus 10 includes a printing machine body 200 and the print control device 100 that controls an operation of the printing machine body 200. The inkjet printing apparatus 10 outputs a print image on printing paper as a print medium based on print data transmitted from the print data generation apparatus 30 without using a printing plate. Note that the present invention can also be applied to a case where a print medium (for example, a film) other than the printing paper is used.

### 2. Configuration of Printing Machine Body of Inkjet Printing Apparatus

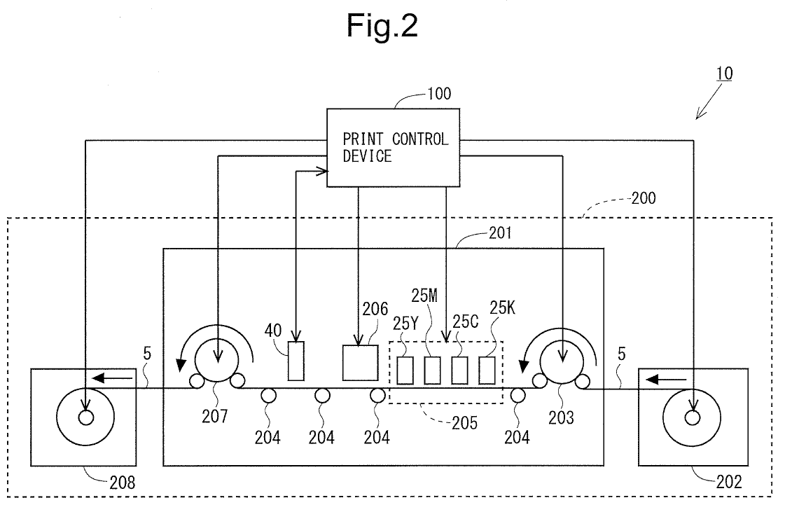

FIG. 2 is a schematic diagram illustrating one configuration example of the inkjet printing apparatus 10. As described above, the inkjet printing apparatus 10 includes the print control device 100 and the printing machine body 200.

The printing machine body 200 includes a paper feeding unit 202 that supplies printing paper (in this example, rolled printing paper) 5 to a printing mechanism 201, the printing mechanism 201 that performs printing on the printing paper 5, and a paper winding unit 208 that winds the printing paper 5 after printing in a roll form.

The printing mechanism 201 includes a first drive roller 203 for conveying the printing paper 5 to the inside, a plurality of support rollers 204 for conveying the printing paper 5 inside the printing mechanism 201, a recording unit 205 that records a print image on the printing paper 5, a drying mechanism 206 that dries the printing paper 5 on which the print image is recorded, and a second drive roller 207 for outputting the printing paper 5 from the inside of the printing mechanism 201. The recording unit 205 includes a K color head unit 25K that ejects K color (black) ink, a C color head unit 25C that ejects C color (cyan) ink, an M color head unit 25M that ejects M color (magenta) ink, and a Y color head unit 25Y that ejects Y color (yellow) ink. Furthermore, the printing mechanism 201 includes an inline scanner 40 as an imaging device that images a print image recorded on the printing paper 5 by the recording unit 205. Captured image data (captured image) obtained by imaging the print image by the inline scanner 40 is sent to the print control device 100. Note that, in the following description, in a case where the color of the ink ejected from the head unit is not distinguished, the head unit is denoted by reference sign 25.

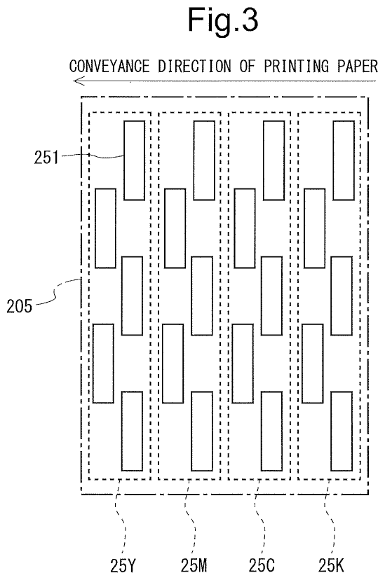

FIG. 3 is a plan view illustrating a configuration example of the recording unit 205. As illustrated in FIG. 3, the recording unit 205 includes the K color head unit 25K, the C color head unit 25C, the M color head unit 25M, and the Y color head unit 25Y arranged in a row in a conveyance direction (sub-scanning direction) of the printing paper 5. Each head unit 25 includes a plurality of ink ejection heads (print heads) 251 arranged in a staggered manner. Each ink ejection head 251 includes a large number of nozzles (not illustrated in FIG. 3) that eject ink. Each nozzle of the ink ejection head 251 included in the K color head unit 25K ejects K color ink, each nozzle of the ink ejection head 251 included in the C color head unit 25C ejects C color ink, each nozzle of the ink ejection head 251 included in the M color head unit 25M ejects M color ink, and each nozzle of the ink ejection head 251 included in the Y color head unit 25Y ejects Y color ink.

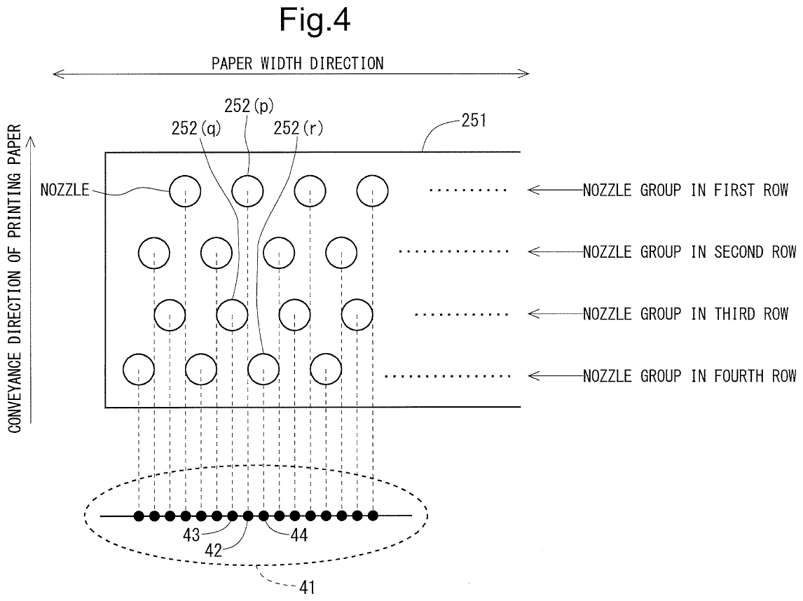

FIG. 4 is a diagram for explaining an arrangement of nozzles in the ink ejection head 251. Typically, the ink ejection head 251 includes a plurality of rows of nozzle groups each including a plurality of nozzles arranged side by side in a paper width direction. In the example illustrated in FIG. 4, four rows of nozzle groups are included in the ink ejection head 251. A portion denoted by reference sign 41 in FIG. 4 schematically illustrates landing positions on the printing paper 5 of the ink ejected from respective nozzles. The plurality of nozzles in the ink ejection head 251 are arranged so that the landing positions of the ink ejected from the nozzles included in the nozzle group in the first row, the landing positions of the ink ejected from the nozzles included in the nozzle group in the second row, the landing positions of the ink ejected from the nozzles included in the nozzle group in the third row, and the landing positions of the ink ejected from the nozzles included in the nozzle group in the fourth row are different positions. For example, the landing position of the ink ejected from each nozzle included in the nozzle group in the first row is a position between the landing position of the ink ejected from the nozzle included in the nozzle group in the third row and the landing position of the ink ejected from the nozzle included in the nozzle group in the fourth row. In the example illustrated in FIG. 4, the landing position 42 of the ink ejected from the nozzle denoted by reference sign 252(p) is a position between the landing position 43 of the ink ejected from the nozzle denoted by reference sign 252(q) and the landing position 44 of the ink ejected from the nozzle denoted by reference sign 252(r).

Note that the configuration illustrated in FIGS. 2 to 4 is an example, and specific configurations of the printing mechanism 201, the recording unit 205, and the ink ejection head 251 are not particularly limited.

### 3. Hardware Configuration of Print Control Device

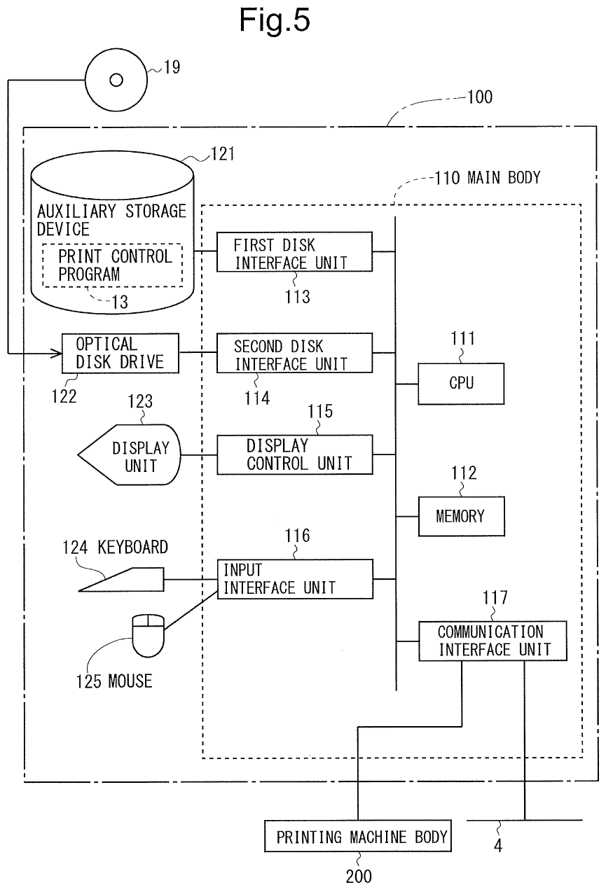

FIG. 5 is a block diagram illustrating a hardware configuration of the print control device 100. As illustrated in FIG. 5, the print control device 100 includes a main body 110, an auxiliary storage device 121, an optical disk drive 122, a display unit 123, a keyboard 124, a mouse 125, and the like. The main body 110 includes a CPU 111, a memory 112, a first disk interface unit 113, a second disk interface unit 114, a display control unit 115, an input interface unit 116, and a communication interface unit 117. The CPU 111, the memory 112, the first disk interface unit 113, the second disk interface unit 114, the display control unit 115, the input interface unit 116, and the communication interface unit 117 are connected to each other via a system bus. The auxiliary storage device 121 is connected to the first disk interface unit 113. The optical disk drive 122 is connected to the second disk interface unit 114. The display unit (display device) 123 is connected to the display control unit 115. The keyboard 124 and the mouse 125 are connected to the input interface unit 116. The printing machine body 200 is connected to the communication interface unit 117 via a communication cable. Furthermore, the communication interface unit 117 is connected to the LAN 4. The auxiliary storage device 121 is a magnetic disk device or the like. An optical disk 19 as a computer-readable recording medium such as a CD-ROM or a DVD-ROM is inserted into the optical disk drive 122. The display unit 123 is a liquid crystal display or the like. The display unit 123 is used to display information desired by an operator. The keyboard 124 and the mouse 125 are used by an operator to input instructions to the print control device 100.

The auxiliary storage device 121 stores a print control program (program for controlling execution of a printing process by the printing machine body 200) 13. The print control program 13 according to the present embodiment includes, as a subprogram, a landing position deviation amount detection program for detecting the magnitude of the landing position deviation (landing position deviation amount), which is one of the types of the ejection defects of the nozzle. The CPU 111 implements various functions of the print control device 100 by reading the print control program 13 stored in the auxiliary storage device 121 into the memory 112 and executing the program. The memory 112 includes a random access memory (RAM) and a read only memory (ROM). The memory 112 functions as a work area for the CPU 111 to execute the print control program 13 stored in the auxiliary storage device 121. Note that the print control program 13 is provided by being stored in the computer-readable recording medium (non-transitory recording medium). That is, for example, the user purchases the optical disk 19 as a recording medium of the print control program 13, inserts the optical disk into the optical disk drive 122, reads the print control program 13 from the optical disk 19, and installs the print control program in the auxiliary storage device 121.

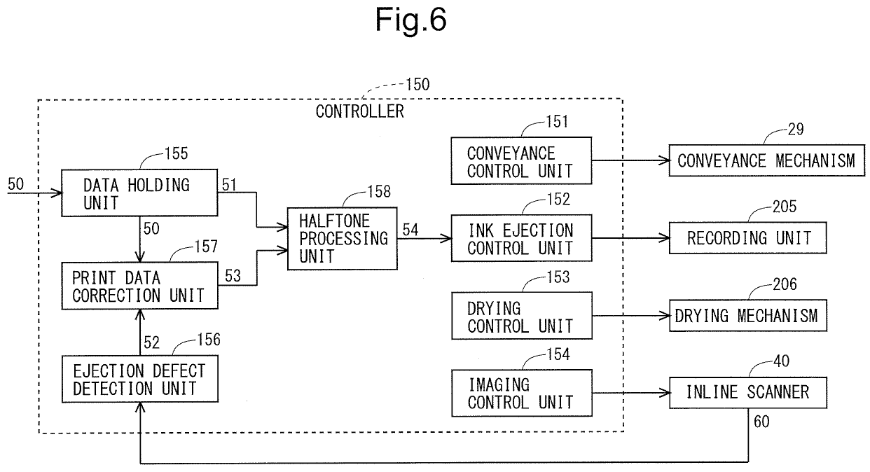

Note that, in the example illustrated in FIG. 5, only one CPU 111 is provided as a processor in the print control device 100, but the present invention is not limited thereto. A configuration using a plurality of processors such as a configuration using a plurality of CPUs can also be adopted. As the processor, in addition to the CPU 111, a micro processing unit (MPU), a graphics processing unit (GPU), a digital signal processor (DSP), or the like can also be adopted. Furthermore, a plurality of types of processors can be used in combination. For example, regarding the components (see FIG. 6) inside a controller 150 to be described later, some components and the remaining components may be realized by different processors. Moreover, a configuration including a field-programmable gate array (FPGA) or an application specific integrated circuit (ASIC) can also be adopted.

### 4. Schematic Functional Configuration of Print Control Device

FIG. 6 is a block diagram illustrating a schematic functional configuration of the controller 150 implemented by the print control device 100 executing the print control program 13. The controller 150 includes a conveyance control unit 151, an ink ejection control unit 152, a drying control unit 153, an imaging control unit 154, a data holding unit 155, an ejection defect detection unit 156, a print data correction unit 157, and a halftone processing unit 158.

The conveyance control unit 151 controls the speed (conveyance speed) at which a conveyance mechanism 29 conveys the printing paper 5. Note that the conveyance mechanism 29 is realized by the paper feeding unit 202, the first drive roller 203, the plurality of support rollers 204, the second drive roller 207, and the paper winding unit 208 (refer to FIG. 2). The drying control unit 153 controls a temperature (drying temperature) when the drying mechanism 206 dries the printing paper 5 after printing. The imaging control unit 154 controls the imaging timing of the print image by the inline scanner 40.

The data holding unit 155 temporarily holds the print data 50 after the rasterization process transmitted from the print data generation apparatus 30. The data holding unit 155 also holds inspection chart data 51 representing an inspection chart for detecting an ejection defect nozzle. Note that the inspection chart will be described in detail later.

The ejection defect detection unit 156 detects an ejection defect nozzle based on a captured image (captured image data) 60 obtained by imaging the print image of the inspection chart with the inline scanner 40. Then, ejection defect information 52 for specifying an ejection defect nozzle is outputted from the ejection defect detection unit 156. Note that the ejection defect detection unit 156 will be described later in detail.

The print data correction unit 157 corrects the print data 50 after the rasterization process held in the data holding unit 155 based on the ejection defect information 52 so that the ejection defects of the nozzle are compensated. Specifically, the print data correction unit 157 corrects the print data 50 based on the ejection defect information 52 so that the ejection defects of the nozzle determined to be in the ejection defect state by the ejection defect detection unit 156 are compensated. More specifically, for example, the print data 50 is corrected so that the ejection amount of ink from the nozzle around the nozzle determined to be in the ejection defect state increases. Then, the print data correction unit 157 outputs corrected print data 53.

The halftone processing unit 158 generates halftone image data 54 including information indicating a dot size of ink corresponding to each pixel by performing a halftone process on data to be printed. As the dot size of the ink, for example, three-stage sizes (L size, M size, S size) are prepared. In the present embodiment, the halftone process is performed on the inspection chart data 51 and the corrected print data 53 outputted from the print data correction unit 157. Note that a specific technique of the halftone process is not particularly limited, and for example, a known technique such as an error diffusion method or a dither method can be adopted.

The ink ejection control unit 152 controls the ejection of ink from each nozzle included in the four head units 25K, 25C, 25M, and 25Y constituting the recording unit 205 based on the halftone image data 54 generated by the halftone processing unit 158. For example, the ink ejection timing and the ink ejection amount are controlled.

### 5. Inspection Chart

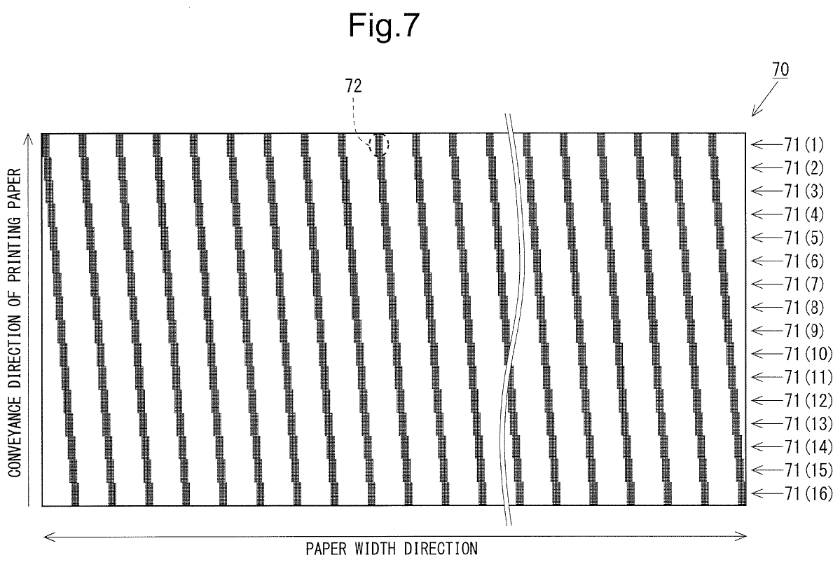

FIG. 7 is a diagram schematically illustrating an example of the inspection chart 70 used in the present embodiment. As illustrated in FIG. 7, the inspection chart 70 includes a stepwise regular pattern. Specifically, the inspection chart 70 includes 16 stages of inspection patterns 71(1) to 71(16), and the inspection pattern 71 of each stage is configured 72 by a plurality of linear patterns 72 extending in the conveyance direction of the printing paper 5 and arranged at equal intervals in the paper width direction. Each linear pattern 72 is formed by ejecting ink from one nozzle. Note that the conveyance direction of the printing paper 5 corresponds to a first direction, and the paper width direction corresponds to a second direction.

In the present embodiment, in order to print the inspection chart 70 including the 16 stages of inspection patterns 71(1) to 71(16) as described above, the plurality of nozzles included in each head unit 25 are grouped into 16 groups. 16 groups and 16 stages of the inspection patterns 71(1) to 71(16) correspond to each other on a one-to-one basis, and the inspection pattern 71 of the stage corresponding to each group is formed on the printing paper 5 by ejecting ink from a plurality of nozzles belonging to the each group.

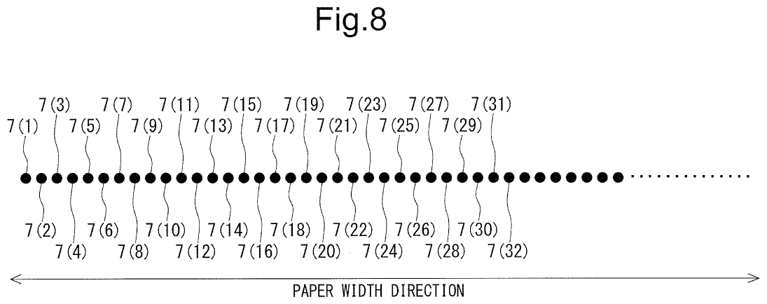

Here, it is assumed that the ink landing positions in the paper width direction in a case where the ejection defects of the nozzle do not occur are as illustrated in FIG. 8. In this case, assuming that the number of nozzles included in the head unit 25 is P (for convenience, it is assumed that P is an integer multiple of 16), Q is any integer of 0 or more and ((P/16)−1) or less, and Z is any integer of 1 or more and 16 or less, for example, nozzles that eject ink to landing positions denoted by reference sign 7(16×Q+Z) in FIG. 8 are included in a group corresponding to the inspection pattern 71(Z) of the Z-th stage.

Note that here, the inspection chart 70 including only a stepwise regular pattern has been exemplified, but the present invention is not limited thereto. For example, in addition to a stepwise regular pattern, a tint pattern having a constant concentration as a whole to be formed by ejecting ink from all the nozzles in one head unit 25 may be included in the inspection chart. Furthermore, although the inspection chart 70 including the 16 stages of the inspection patterns 71(1) to 71(16) is illustrated here, the present invention is not limited thereto. It is possible to use the inspection chart 70 including the M-stage inspection patterns 71 in one-to-one correspondence with the M groups obtained by grouping the plurality of nozzles, where M is an integer of 2 or more.

### 6. Schematic Procedure of Landing Position Deviation Detection

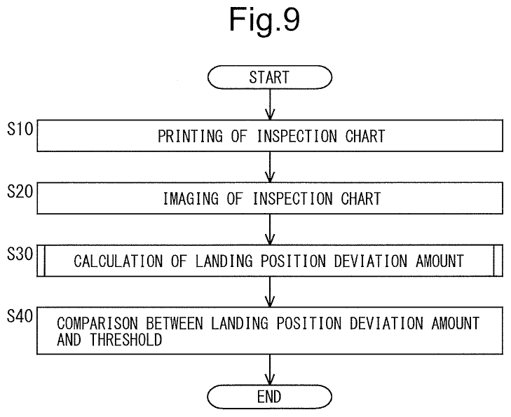

A schematic procedure of the landing position deviation detection will be described with reference to a flowchart illustrated in FIG. 9. First, printing of the inspection chart 70 is performed (step S10). Specifically, halftone processing by the halftone processing unit 158 is performed on the inspection chart data 51 held in the data holding unit 155, and the ink ejection control unit 152 controls ejection of ink from each nozzle on the basis of the halftone image data 54 obtained by the halftone processing, whereby the inspection chart 70 is printed on the printing paper 5. After printing the inspection chart 70, the inline scanner 40 images the print image of the inspection chart 70 (the print image obtained in step S10) under the control of the imaging control unit 154 (step S20). Thereafter, the ejection defect detection unit 156 calculates the landing position deviation amount for each nozzle included in each head unit 25 (the landing position deviation amount of the ink ejected from each nozzle) based on the captured image 60 obtained in step S20 (step S30). Note that the process performed in step S30 will be described in detail later. After the landing position deviation amount is calculated, the landing position deviation amount is compared with a predetermined threshold (step S40). As a result, when the landing position deviation amount is larger than the threshold, it is determined that the target nozzle has caused the landing position deviation. On the other hand, when the landing position deviation amount is equal to or less than the threshold, it is determined that the target nozzle has not caused the landing position deviation.

By the way, although the detection of the landing position deviation has been focused here, non-ejection and shape defects are also detected in actual operation. In this regard, a specific technique for detecting non-ejection and shape defects is not particularly limited. For example, the non-ejection and the shape defects can be detected by a technique using machine learning.

Note that, in the present embodiment, printing an inspection chart is realized by step S10, and imaging the inspection chart is realized by step S20. Furthermore, an inspection chart printing process is realized by the process of step S10, and an inspection chart imaging process is realized by the process of step S20.

### 7. Calculation of Landing Position Deviation Amount

Hereinafter, the calculation of the landing position deviation amount will be described in detail. Here, first, a procedure in the comparative example will be described, and then, a configuration and a procedure in the present embodiment will be described.

### 7.1 Calculation of Landing Position Deviation Amount in Comparative Example

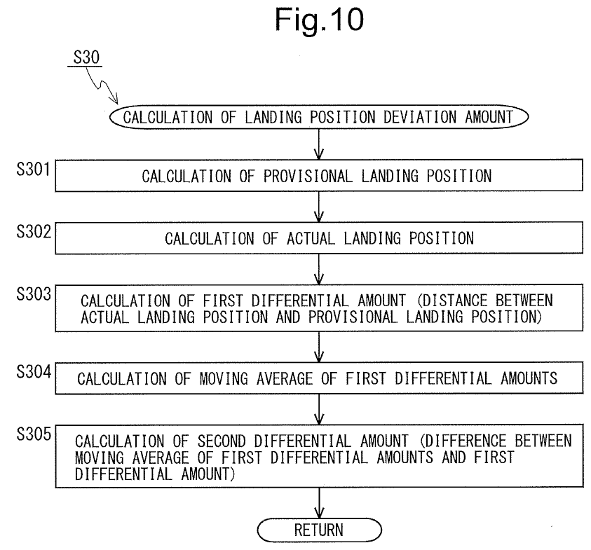

A procedure of calculating the landing position deviation amount in the comparative example will be described with reference to the flowchart illustrated in FIG. 10. First, a position at which the ink ejected from each nozzle is assumed to land on the printing paper 5 (the position is referred to as a “provisional landing position”) is calculated based on the captured image 60 of the inspection chart 70 and the design information of the inspection chart 70 (step S301). Next, based on the captured image 60 of the inspection chart 70, a position where the ink ejected from each nozzle has actually landed on the printing paper 5 (the position is referred to as an “actual landing position”) is calculated (step S302).

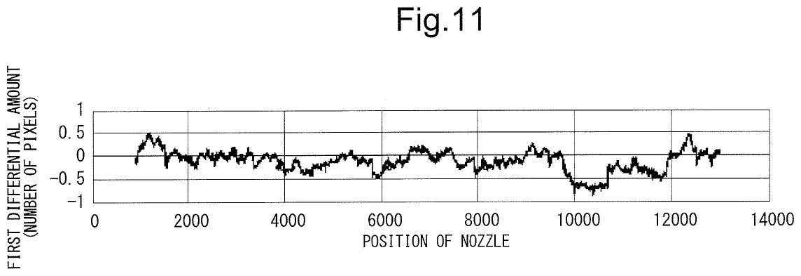

Thereafter, for each nozzle, a distance between the actual landing position obtained in step S302 and the provisional landing position obtained in step S301 (a difference between the actual landing position and the provisional landing position) is obtained as a first differential amount (step S303). Note that here, it is assumed that the first differential amount is a positive value if the actual landing position is deviated rightward from the provisional landing position toward the conveyance direction of the printing paper 5, and the first differential amount is a negative value if the actual landing position is deviated leftward from the provisional landing position toward the conveyance direction of the printing paper 5. FIG. 11 is an example of a graph illustrating the first differential amounts obtained based on the captured image 60 of the inspection pattern 71 of a certain stage. As described above, when printing is performed on the printing paper 5, the printing paper 5 being conveyed may expand and contract. Therefore, even if the landing position deviation as the ejection defects of the nozzle does not occur, the first differential amount varies depending on the position of the nozzle as can be grasped from FIG. 11.

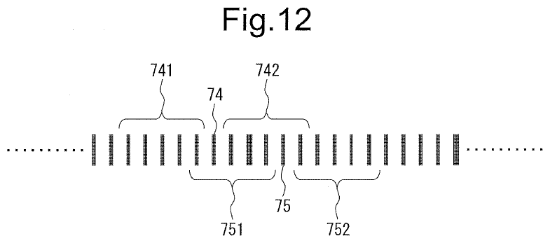

After the first differential amount is calculated, a moving average of the first differential amounts in the paper width direction is obtained (step S304). When any nozzle is referred to as a “focused nozzle”, a moving average corresponding to the focused nozzle is obtained using first differential amounts of n nozzles that are to land ink at a position close to a landing position of the ink ejected from the focused nozzle, where n is a natural number. When n is 10, the moving average corresponding to the focused nozzle is calculated by dividing the sum of the first differential amounts of the 10 nozzles that are to land the ink at a position close to the landing position of the ink ejected from the focused nozzle by 10. In this regard, it is assumed that an image as illustrated in FIG. 12 is obtained as the captured image 60 of the inspection pattern 71 of a certain stage. In this case, for example, the moving average corresponding to the nozzle forming the linear pattern denoted by reference sign 74 is calculated by dividing the sum of the first differential amounts of the five nozzles forming the linear pattern present in the portion denoted by reference sign 741 and the five nozzles forming the linear pattern present in the portion denoted by reference sign 742 by 10. Furthermore, for example, the moving average corresponding to the nozzle forming the linear pattern denoted by reference sign 75 is calculated by dividing the sum of the first differential amounts of the five nozzles forming the linear pattern present in the portion denoted by reference sign 751 and the five nozzles forming the linear pattern present in the portion denoted by reference sign 752 by 10.

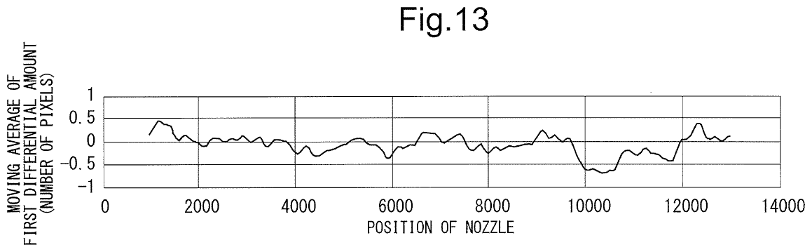

FIG. 13 is a graph illustrating moving averages of the first differential amounts when the graph illustrating the first differential amounts is the graph illustrated in FIG. 11. As can be grasped by comparing FIG. 11 and FIG. 13, in the graph representing the moving averages of the first differential amounts, the value changes smoothly as compared with the graph representing the first differential amounts. That is, the graph representing the moving averages of the first differential amounts indicates the overall tendency of the first differential amounts in the paper width direction.

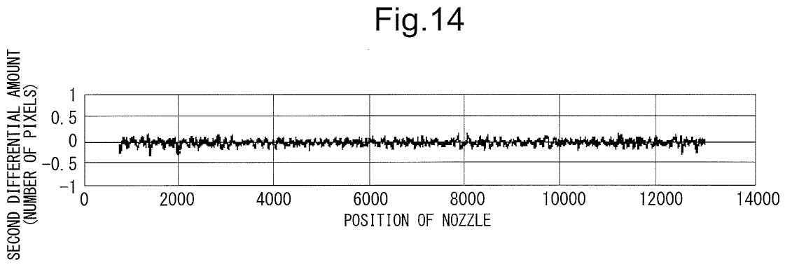

After the moving average of the first differential amounts is calculated, a difference between the first differential amount obtained in step S303 and the moving average obtained in step S304 is obtained as a second differential amount (step S305). More specifically, the second differential amount is obtained by subtracting the moving average obtained in step S304 from the first differential amount obtained in step S303. When the graph representing the first differential amounts is the graph illustrated in FIG. 11 and the graph representing the moving averages is the graph illustrated in FIG. 13, the graph representing the second differential amounts is as illustrated in FIG. 14. As can be grasped by comparing FIG. 11 and FIG. 14, the second differential amounts are values closer to 0 as a whole than the first differential amounts.

In this comparative example, the second differential amount obtained in step S305 is treated as the landing position deviation amount, and whether or not the landing position deviation has occurred is determined by comparing the landing position deviation amount with a predetermined threshold.

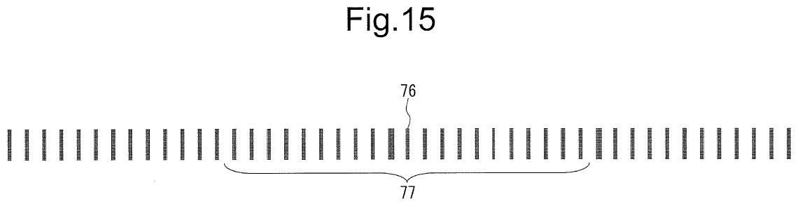

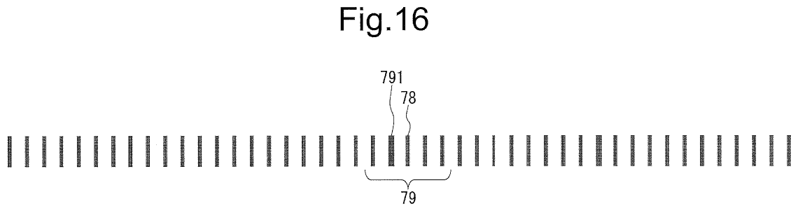

However, according to the technique of the comparative example, similarly to the technique described in Japanese Laid-Open Patent Publication No. 2011-194734, the landing position deviation cannot be detected with sufficient accuracy due to the use of the moving average. For example, in a case where data corresponding to each of the 20 nozzles is used when the moving average is obtained, the moving average of the first differential amounts of the nozzles corresponding to the linear pattern denoted by reference sign 76 in FIG. 15 is obtained using data corresponding to each of the nozzles forming linear patterns present within a range denoted by reference sign 77 in FIG. 15 (however, a linear pattern denoted by reference sign 76 is excluded). In a range denoted by reference sign 77 in FIG. 15, the state of expansion and contraction of the printing paper 5 may greatly differ depending on the position (that is, the relationship between the actual landing position and the provisional landing position may greatly differ depending on the position). Thus, even if the moving average of the first differential amounts is subtracted from the first differential amount, the landing position deviation amount is not accurately calculated. Furthermore, for example, in a case where data corresponding to each of the four nozzles is used when the moving average is obtained, the moving average of the first differential amounts for the nozzles corresponding to the linear pattern denoted by reference sign 78 in FIG. 16 is obtained using data corresponding to each of the nozzles forming linear patterns present within a range denoted by reference sign 79 in FIG. 16 (however, a linear pattern denoted by reference sign 78 is excluded). Here, it is assumed that a linear pattern denoted by reference sign 791 in FIG. 16 is formed by a nozzle causing the landing position deviation. In this case, since the number of data used for calculation of the moving average is small, the data corresponding to the nozzle causing the landing position deviation causes a relatively large error in the calculation result of the moving average. As a result, even if the moving average of the first differential amounts is subtracted from the first differential amount, the landing position deviation amount is not accurately calculated.

### 7.2 Calculation of Landing Position Deviation Amount in Present Embodiment

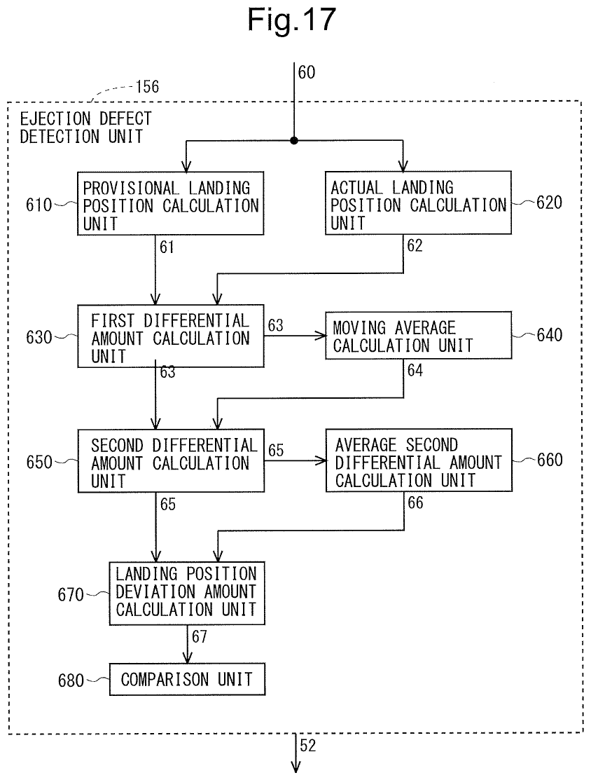

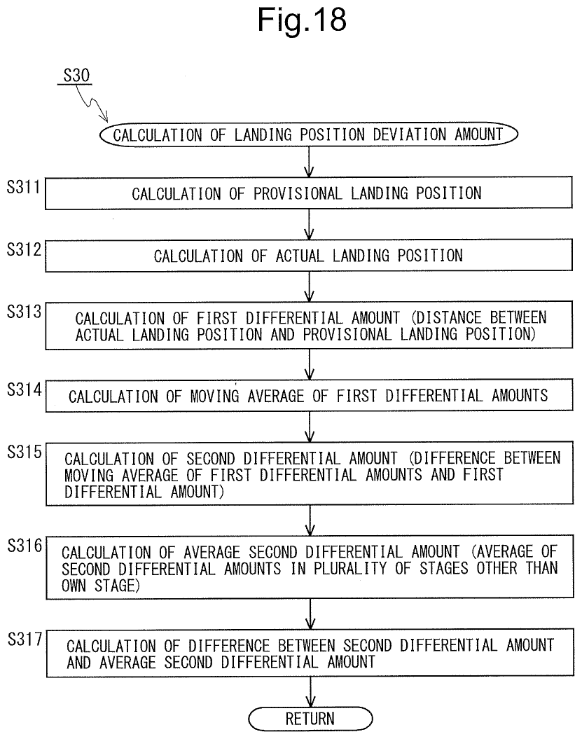

Next, calculation of the landing position deviation amount in the present embodiment will be described. FIG. 17 is a block diagram illustrating a detailed configuration of the ejection defect detection unit 156 in the present embodiment. FIG. 18 is a flowchart illustrating a procedure of calculating the landing position deviation amount in the present embodiment.

As illustrated in FIG. 17, the ejection defect detection unit 156 includes a provisional landing position calculation unit 610, an actual landing position calculation unit 620, a first differential amount calculation unit 630, a moving average calculation unit 640, a second differential amount calculation unit 650, an average second differential amount calculation unit 660, a landing position deviation amount calculation unit 670, and a comparison unit 680. Note that the ejection defect detection unit 156 also includes a component for detecting non-ejection and a component for detecting shape defects, which are not illustrated in FIG. 17.

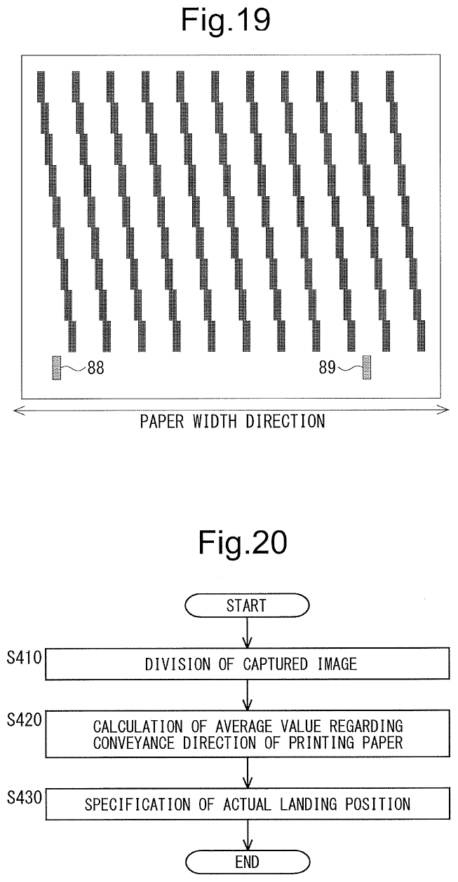

When the landing position deviation amount is calculated, first, the provisional landing position calculation unit 610 calculates the provisional landing position 61 based on the captured image 60 of the inspection chart 70 and the design information of the inspection chart 70 (step S311). Specifically, the provisional landing position 61 is obtained as follows, for example. At the time of printing the inspection chart 70 (step S10 in FIG. 9), for example, as illustrated in FIG. 19, position marks 88 and 89 for obtaining the provisional landing position 61 are also printed. Then, based on the captured image of the print image (the captured image obtained in step S20 in FIG. 9), the number of linear patterns present in the region corresponding to between the two position marks 88 and 89 is counted. The nozzle pitch (distance between two nozzles adjacent in the paper width direction) is obtained based on the count value (that is, the number of nozzles that are to land the ink on the region corresponding to the space between the two position marks 88 and 89) obtained as a result and the positions (coordinates) of the two position marks 88 and 89. Then, based on the position (coordinates) of one position mark 88 and the nozzle pitch, the provisional landing position 61 for each nozzle that ejects ink to the region corresponding to between the two position marks 88 and 89 is obtained. Note that, in the present embodiment, the provisional landing position 61 corresponds to the reference position.

Next, the actual landing position calculation unit 620 calculates the actual landing position 62 based on the captured image 60 of the inspection chart 70 (step S312). The calculation of the actual landing position 62 will be further described with reference to a flowchart illustrated in FIG. 20.

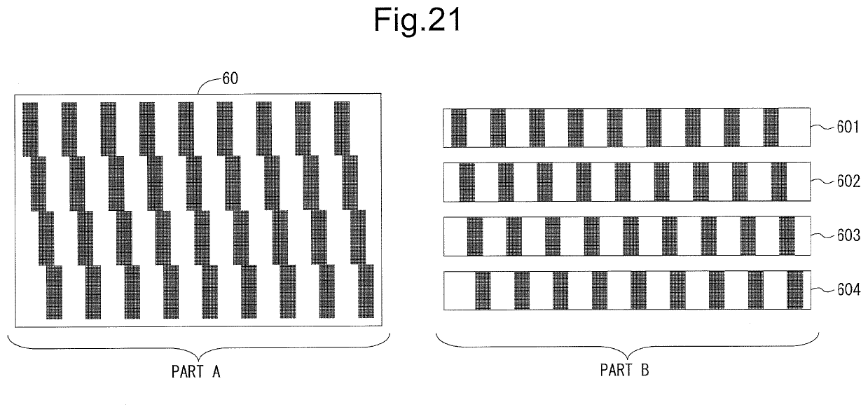

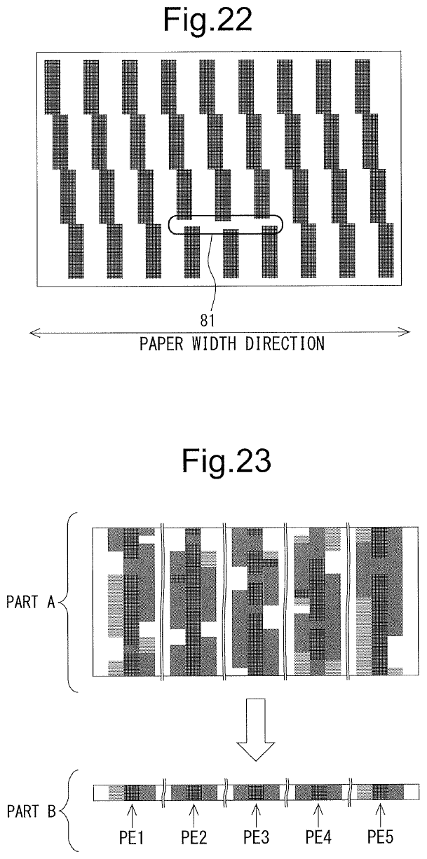

First, the captured image 60 is divided into K parts (divided images) in the conveyance direction of the printing paper 5 with K being an integer of 2 or more (step S410). In step S410, the boundaries between the stages are obtained on the basis of the design information of the inspection chart 70 or the pixel values of the captured image 60, and the captured image 60 is divided such that the divided image corresponds to one stage (in other words, the divided image corresponds to one nozzle regarding the conveyance direction of the printing paper 5). For example, when a captured image 60 as illustrated in a part A of FIG. 21 is obtained, the captured image 60 is divided into four divided images 601 to 604 as illustrated in a part B of FIG. 21. Note that a boundary portion between a certain stage and the next stage contains a lot of noise. For example, as illustrated in a portion denoted by reference sign 81 in FIG. 22, a gap due to adjustment of the ink ejection head 251 may occur. Therefore, it is preferable to remove the upper end portion and the lower end portion (that is, the boundary portion between the stages) of the divided image by trimming.

Next, for each of the K divided images obtained in step S410, an average value of data (pixel values) of a plurality of pixels included in the conveyance direction of the printing paper 5 is calculated (step S420). This corresponds to, for example, converting a captured image as illustrated in a part A of FIG. 23 into one-dimensional data as schematically illustrated in a part B of FIG. 23. Note that it is preferable to perform normalization to set the paper white portion to 0 and the maximum density portion to 255, for example, on the data of the average value obtained in step S420.

Finally, the actual landing position 62 for each nozzle is obtained based on the average values (preferably, the average values after normalization is performed) calculated in step S420 (step S430). Regarding this, the peak position is calculated as a real number using a technique such as gravity center calculation, equiangular straight line fitting, spline interpolation, or Gaussian fitting on the basis of the value of the pixel (for example, each of pixels denoted by reference signs PE1 to PE5 in part B of FIG. 23) in which the peak of the average value is obtained and the values of the neighboring pixels (for example, on the basis of the values of a total of three pixels), and the peak position is determined as the actual landing position 62.

Note that, regarding the calculation of the actual landing position 62, dividing the captured image into K images is realized by step S410, calculating an average value is realized by step S420, and specifying the actual landing position is realized by step S430.

After the calculation of the actual landing position 62, the first differential amount calculation unit 630 obtains a distance (difference between the actual landing position and the provisional landing position) between the actual landing position 62 obtained in step S312 and the provisional landing position 61 obtained in step S311 as the first differential amount 63 (step S313). An example of a graph representing the first differential amounts 63 obtained based on the captured image 60 of the inspection pattern 71 of a certain stage is as illustrated in FIG. 11.

Next, the moving average calculation unit 640 obtains the moving average 64 of the first differential amounts 63 in the paper width direction based on the first differential amounts 63 obtained in step S313 (step S314). As described above, when any nozzle is referred to as a “focused nozzle”, the moving average 64 corresponding to the focused nozzle is obtained using the first differential amounts 63 of the n nozzles that are to land the ink at a position close to the landing position of the ink ejected from the focused nozzle, where n is a natural number. More specifically, the average of the first differential amounts 63 of two or more nozzles (n nozzles) that belong to the same group as the focused nozzle and should land the ink at a position within a predetermined distance in the paper width direction from the position where the focused nozzle should land the ink is obtained as the moving average 64 corresponding to the focused nozzle.

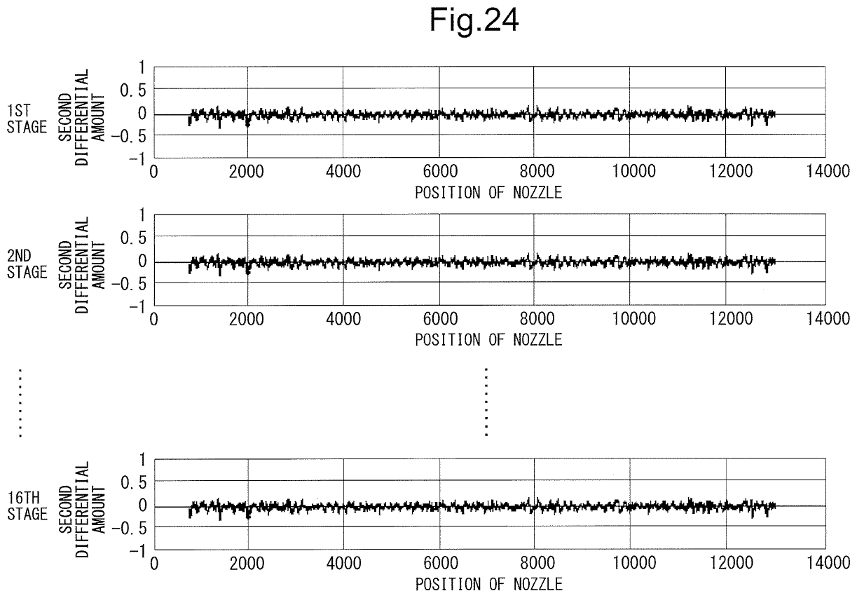

Thereafter, the second differential amount calculation unit 650 obtains a difference between the first differential amount 63 obtained in step S313 and the moving average 64 obtained in step S314 as the second differential amount 65 (step S315). Specifically, the second differential amount calculation unit 650 obtains the second differential amount 65 by subtracting the moving average 64 obtained in step S314 from the first differential amount 63 obtained in step S313. By obtaining the second differential amount 65 for each nozzle for each stage of the inspection pattern in step S315, as schematically illustrated in FIG. 24, 16 graphs respectively corresponding to the 16 stages of the inspection patterns 71(1) to 71(16) and representing the second differential amount 65 for each nozzle are obtained. Note that the processing of steps S311 to S315 in the present embodiment is the same as the processing of steps S301 to S305 in the comparative example.

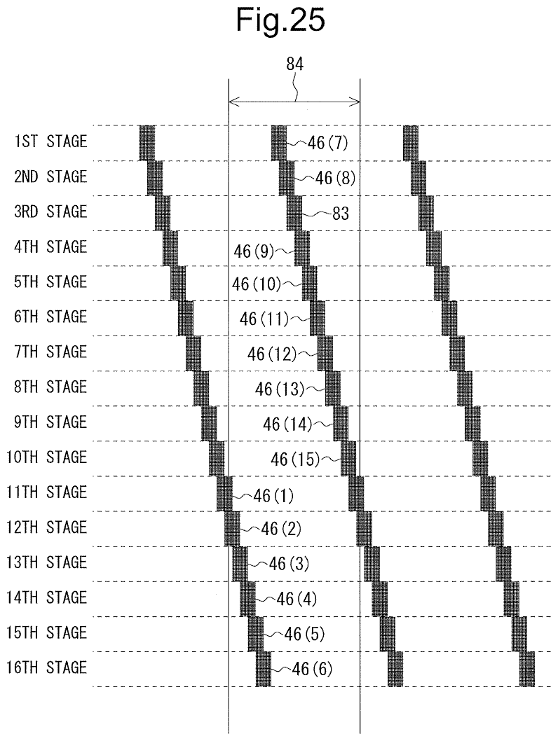

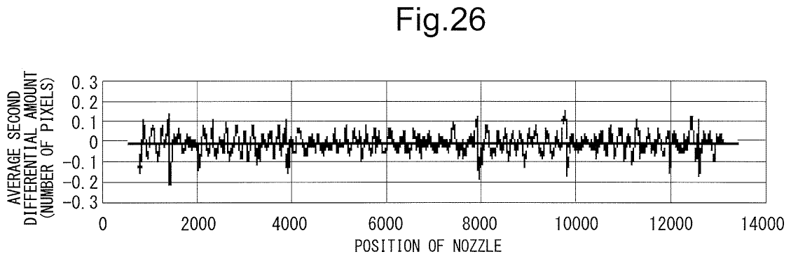

After calculating the second differential amount 65, the average second differential amount calculation unit 660 obtains an average of the second differential amounts 65 at a position of each nozzle as the average second differential amount 66 (step S316). In step S316, the average second differential amount 66 is calculated as follows with each of the plurality of nozzles included in the head unit 25 as the focused nozzle. Here, a nozzle corresponding to a linear pattern denoted by reference sign 83 in FIG. 25 is taken as the focused nozzle, and how to obtain the average second differential amount 66 for the focused nozzle will be described. As can be grasped from FIG. 25, the focused nozzle belongs to the group corresponding to the inspection pattern 71(3) of the third stage. In this case, when calculating the average second differential amount 66, the data of the second differential amounts 65 of the nozzles that belong to the group other than the group corresponding to the inspection pattern 71(3) of the third row and should land the ink at the position close to the position where the focused nozzle should land the ink in the paper width direction is used. Specifically, data of the second differential amounts 65 of 15 nozzles that are to land ink within a range represented by an arrow denoted by reference sign 84 in FIG. 25, that is, data of the second differential amounts 65 of 15 nozzles corresponding to 15 linear patterns denoted by reference signs 46(1) to 46(15) in FIG. 25 is used. Therefore, the 15 nozzles are associated with the focused nozzle in advance. As a result, the average of the second differential amounts 65 of the 15 nozzles is taken as the average second differential amount 66 for the focused nozzle. As above, in the present embodiment, in step S316, the average of the second differential amounts 65 of the nozzles belonging to each of all the groups different from the group to which the focused nozzle belongs and associated in advance with the focused nozzle is obtained as the average second differential amount 66 corresponding to the focused nozzle. The average second differential amounts 66 are calculated by sequentially setting the plurality of nozzles belonging to the group corresponding to the inspection pattern 71(3) of the third stage as the focused nozzle, whereby a graph as illustrated in FIG. 26 is obtained as a graph representing the average second differential amounts 66, for example.

Meanwhile, the second differential amount 65 is affected not only by the landing position deviation but also by the expansion and contraction of the printing paper 5 and an error generated when the inline scanner 40 images the print image of the inspection chart 70 (however, in the following, attention is paid to the influence of expansion and contraction of the printing paper 5). The average second differential amount 66 is obtained by averaging such second differential amounts 65. In general, the number of nozzles causing the landing position deviation is significantly smaller than the number of nozzles included in the head unit 25. Therefore, the average second differential amount 66 is hardly affected by the landing position deviation. From the above, the average second differential amount 66 is mainly affected by the expansion and contraction of the printing paper 5.

After the average second differential amount 66 is calculated, the landing position deviation amount calculation unit 670 obtains a difference between the second differential amount 65 obtained in step S315 and the average second differential amount 66 obtained in step S316 as the landing position deviation amount 67 for each nozzle (step S317). More specifically, the landing position deviation amount 67 is obtained by subtracting the average second differential amount 66 obtained in step S316 from the second differential amount 65 obtained in step S315.

After the difference between the second differential amount 65 and the average second differential amount 66 is calculated as the landing position deviation amount 67 as described above, the comparison unit 680 compares the landing position deviation amount 67 with a predetermined threshold. As a result, when the landing position deviation amount is larger than the threshold, it is determined that the target nozzle causes the landing position deviation, and when the landing position deviation amount is equal to or less than the threshold, it is determined that the target nozzle does not cause the landing position deviation. In accordance with the determination, the ejection defect information 52 is outputted from the ejection defect detection unit 156.

Note that, in the present embodiment, obtaining a reference position is realized by step S311, obtaining an actual landing position is realized by step S312, obtaining a first differential amount is realized by step S313, obtaining a moving average is realized by step S314, obtaining a second differential amount is realized by step S315, obtaining an average second differential amount is realized by step S316, and obtaining a landing position deviation amount is realized by step S317. Furthermore, a reference position calculation process is realized by the process of step S311, an actual landing position calculation process is realized by the process of step S312, a first differential amount calculation process is realized by the process of step S313, a moving average calculation process is realized by the process of step S314, a second differential amount calculation process is realized by the process of step S315, an average second differential amount calculation process is realized by the process of step S316, and a landing position deviation amount calculation process is realized by the process of step S317.

### 8. Effects

According to the present embodiment, after the difference between the “difference (first differential amount 63) between the actual landing position 62 and the provisional landing position 61” and the “moving average 64 of the differences (first differential amounts 63) between the actual landing position 62 and the provisional landing position 61” is obtained as the second differential amount 65, the average of the second differential amounts 65 for the nozzles belonging to a group different from the focused nozzle is obtained as the average second differential amount 66 corresponding to the focused nozzle. Then, the difference between the second differential amount 65 and the average second differential amount 66 is obtained as the landing position deviation amount. Here, the second differential amount 65 is affected by the landing position deviation and the expansion and contraction of the printing paper 5. Furthermore, the average second differential amount 66 is mainly affected by expansion and contraction of the printing paper 5. Therefore, by adopting the difference between the second differential amount 65 and the average second differential amount 66 as the landing position deviation amount 67, even if the number of data used in obtaining the moving average is increased, the influence of the expansion and contraction of the printing paper 5 with respect to the landing position deviation amount 67 obtained for each nozzle can be made smaller than before. That is, the landing position deviation amount 67 is accurately obtained.

The fact that the landing position deviation amount 67 is accurately obtained will be described using virtual numerical values. The deviation amount of the printing paper at the position of the focused nozzle is assumed to be 20 μm, and the actual landing position deviation amount for the focused nozzle is assumed to be 10 μm. In this case, the first differential amount 63 is 30 μm. Here, the moving average 64 of the first differential amounts 63 is assumed to be 23 μm. In this case, the second differential amount 65 is 7 μm (=30 μm−23 μm). Since the actual landing position deviation amount is 10 μm, 3 μm (=10 μm−7 μm) is an error caused by increasing the number of data used for calculation of the moving average 64. When a nozzle associated with the focused nozzle in advance in order to obtain the average second differential amount 66 is referred to as a “corresponding nozzle”, it is considered that the deviation amount of the printing paper 5 at the position of the corresponding nozzle is substantially equal to the deviation amount (20 μm) of the printing paper 5 at the position of the focused nozzle. Furthermore, it is considered that the “moving average 64 of the first differential amounts 63” for the corresponding nozzle is substantially equal to the “moving average 64 of the first differential amounts 63” (23 μm) for the focused nozzle. Moreover, as described above, the average second differential amount 66 is hardly affected by the landing position deviation. From the above, the average second differential amount 66 is about −3 μm (=20 μm−23 μm). As a result, the landing position deviation amount 67 is about 10 μm (=7 μm−(−3 μm)). Thus, the landing position deviation amount 67 obtained by the technique of the present embodiment is substantially equal to the actual landing position deviation amount.

Next, the deviation amount of the printing paper 5 at the position of the focused nozzle is assumed to be 20 μm, and the actual landing position deviation amount for the focused nozzle is assumed to be 0 μm. In this case, the first differential amount 63 is 20 μm. Again, the moving average 64 of the first differential amounts 63 is assumed to be 23 μm. In this case, the second differential amount 65 is −3 μm (=20 μm−23 μm). Since the actual landing position deviation amount is 0 μm, 3 μm (=0 μm−(−3 μm)) is an error caused by increasing the number of data used for calculation of the moving average 64. Also in this example, the average second differential amount 66 is about −3 μm (=20 μm−23 μm). As a result, the landing position deviation amount 67 is about 0 μm (=−3 μm−(−3 μm)). Thus, the landing position deviation amount 67 is accurately obtained also for the nozzle that does not cause the landing position deviation.

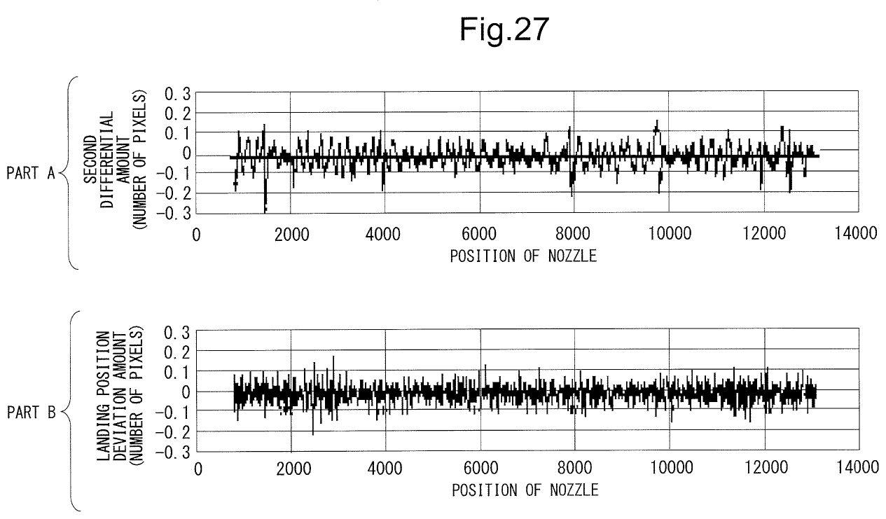

With respect to a case where data corresponding to each of the 20 nozzles is used when the moving average 64 of the first differential amounts 63 is obtained, a graph representing the second differential amounts (the landing position deviation amount in the comparative example) 65 is illustrated in a part A of FIG. 27, and a graph representing the landing position deviation amounts 67 is illustrated in a part B of FIG. 27. In this case, the standard deviation of the second differential amount 65 is 0.64 pixels (2.7 μm), whereas the standard deviation of the landing position deviation amount 67 is 0.47 pixels (2.0 μm). Note that the imaging resolution of the inline scanner 40 is 600 dpi. Since the number of nozzles causing the landing position deviation is significantly smaller than the number of nozzles included in the head unit 25 as described above, the standard deviation of the second differential amount 65 and the standard deviation of the landing position deviation amount 67 should be close to 0. Considering this, since the standard deviation of the landing position deviation amount 67 in the present embodiment is smaller than the standard deviation of the second differential amount (the landing position deviation amount in the comparative example) 65, it can be grasped that the accuracy of the calculation of the landing position deviation amount is higher in the present embodiment than in the comparative example. Since the landing position deviation amount can be obtained with high accuracy in this manner, the landing position deviation can be detected with high accuracy.

As above, according to the present embodiment, regarding the inkjet printing apparatus, it is possible to accurately detect the size of the landing position deviation (landing position deviation amount), which is one type of the ejection defects of the nozzle. Furthermore, since the landing position deviation that cannot be detected by the conventional technique can be detected, wasteful consumption of the printing paper 5 and ink due to reprinting is suppressed. Thus, it is possible to contribute to the achievement of the SDGs (sustainable development goals).

### 9. Modifications

Hereinafter, modifications of the above embodiment will be described.

### 9.1 First Modification

In the above embodiment, the difference between the moving average 64 of the first differential amounts 63 and the first differential amount 63 is obtained as the second differential amount 65. However, the present invention is not limited thereto. The configuration may be such that the sum of the provisional landing position 61 and the moving average 64 of the first differential amounts 63 is obtained as the ideal landing position, and the difference between the actual landing position 62 and the ideal landing position is obtained as the second differential amount 65.

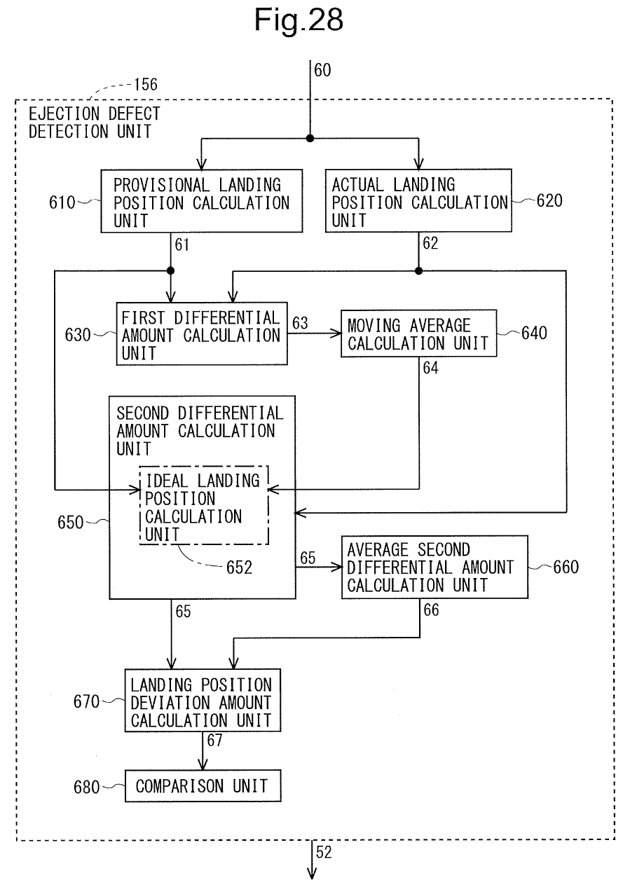

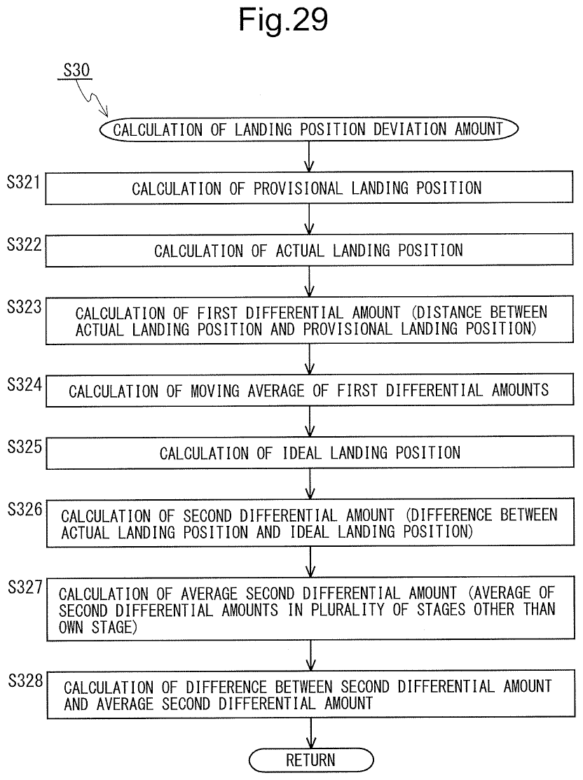

FIG. 28 is a block diagram illustrating a detailed configuration of the ejection defect detection unit 156 in the present modification. FIG. 29 is a flowchart illustrating a procedure of calculating a landing position deviation amount in the present modification. Hereinafter, differences from the above-described embodiment in the present modification will be described.

Steps S321 to S324 are the same as steps S311 to S314 in the above embodiment. After the moving average 64 of the first differential amounts 63 is calculated in step S324, an ideal landing position calculation unit 652 obtains an ideal position (ideal landing position) on which the ink ejected from each nozzle should land (step S325). Specifically, the ideal landing position calculation unit 652 obtains the ideal landing position by adding the provisional landing position 61 obtained in step S321 and the moving average 64 obtained in step S324. Then, the second differential amount calculation unit 650 obtains a difference between the actual landing position 62 obtained in step S322 and the ideal landing position obtained in step S325 as the second differential amount 65 (step S326). Specifically, the second differential amount calculation unit 650 obtains the second differential amount 65 by subtracting the ideal landing position obtained in step S325 from the actual landing position 62 obtained in step S322. Steps S327 and S328 are the same as steps S316 and S317 in the above embodiment.

According to the present modification, the difference between the actual landing position 62 and the ideal landing position is obtained as the second differential amount 65. Here, the ideal landing position is the sum of the provisional landing position 61 and the moving average 64 of the first differential amounts 63. Therefore, the difference between the actual landing position 62 and the “sum of the provisional landing position 61 and the moving average 64 of the first differential amounts 63” is the second differential amount 65. That is, the second differential amount 65 is obtained by subtracting the moving average 64 of the first differential amounts 63 from the difference between the actual landing position 62 and the provisional landing position 61. Since the difference between the actual landing position 62 and the provisional landing position 61 is the first differential amount 63, the second differential amount 65 is obtained by subtracting the moving average 64 of the first differential amount 63 from the first differential amount 63. From the above, the second differential amount 65 obtained in the present modification is equal to the second differential amount 65 obtained in the above embodiment. Therefore, the landing position deviation amount 67 obtained in the present modification is equal to the landing position deviation amount 67 obtained in the above embodiment. Accordingly, according to the present modification, as in the above embodiment, regarding the inkjet printing apparatus, it is possible to accurately detect the size of the landing position deviation (landing position deviation amount), which is one type of the ejection defects of the nozzle.

### 9.2 Second Modification

In the above embodiment, when the average second differential amount 66 for the focused nozzle is obtained, the data of the second differential amounts 65 of the nozzles belonging to each of all the groups different from the group to which the focused nozzle belongs is used. However, the present invention is not limited thereto. The average second differential amount 66 for the focused nozzle may be obtained using the data of the second differential amounts 65 of a predetermined number of nozzles belonging to each of some groups (two or more groups) different from the group to which the focused nozzle belongs.

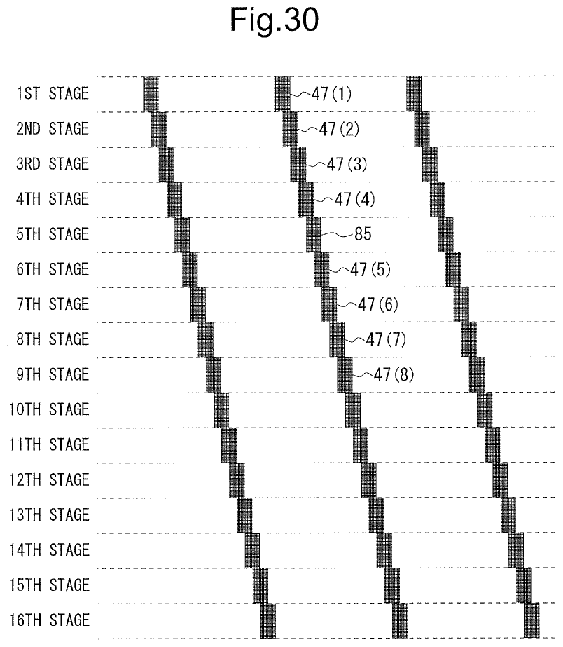

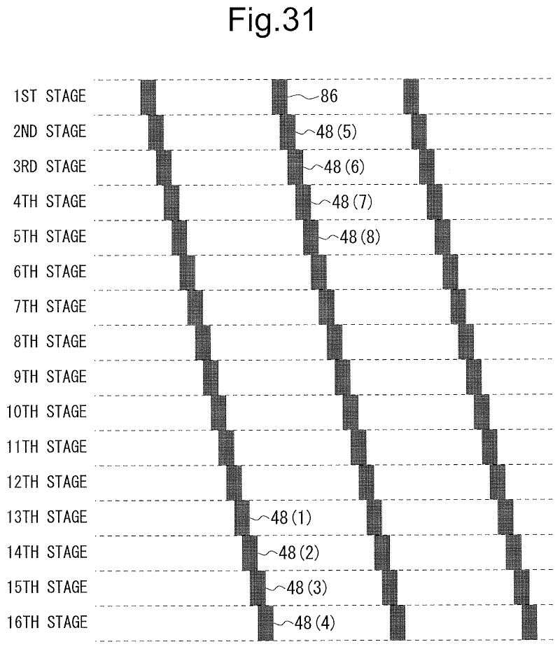

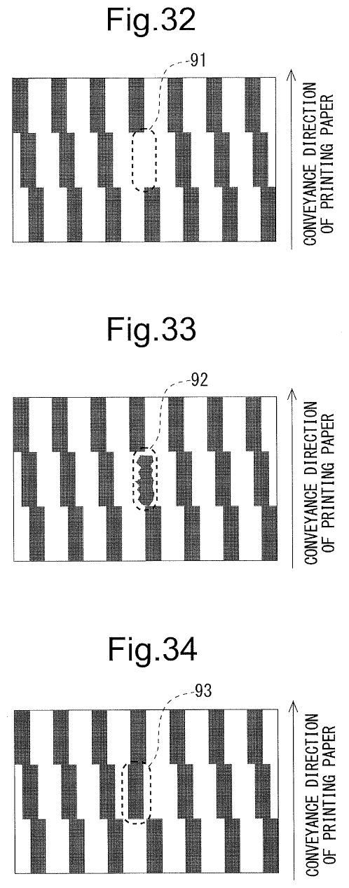

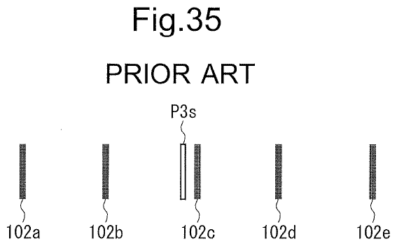

In the present modification, for example, the average second differential amount 66 for the focused nozzle is obtained using the data of the second differential amount 65 of the eight nozzles (nozzles belonging to each of the eight groups) that should land the ink at the position in the vicinity (the vicinity with respect to the paper width direction) of the position where the focused nozzle should land the ink. In this case, the average second differential amount 66 for the nozzle corresponding to the linear pattern denoted by reference sign 85 in FIG. 30 is obtained by calculating the average of the second differential amounts 65 of the eight nozzles respectively corresponding to the eight linear patterns denoted by reference signs 47(1) to 47(8) in FIG. 30. Furthermore, the average second differential amount 66 for the nozzle corresponding to the linear pattern denoted by reference sign 86 in FIG. 31 is obtained by calculating the average of the second differential amounts 65 of the eight nozzles respectively corresponding to the eight linear patterns denoted by reference signs 48(1) to 48(8) in FIG. 31. Note that, in order to realize this, each nozzle is associated with eight nozzles in advance as described above.

As above, in the present modification, in step S316 of FIG. 18, the average of the second differential amounts 65 of the nozzles belonging to each of some groups (two or more groups) different from the group to which the focused nozzle belongs and are associated in advance with the focused nozzle is obtained as the average second differential amount 66 corresponding to the focused nozzle.

According to the present modification, regarding the inkjet printing apparatus, it is possible to accurately detect the size of the landing position deviation (landing position deviation amount), which is one type of the ejection defects of the nozzle, while suppressing the increase in the calculation load.

### 10. Others

The present invention is not limited to the above embodiment (including the modifications), and various modifications can be made without departing from the gist of the present invention.

For example, in the above-described embodiment (including the modifications), the inkjet printing apparatus 10 that performs color printing has been adopted. However, the present invention is not limited thereto, and an inkjet printing apparatus that performs monochrome printing may be adopted.

Furthermore, in the above-described embodiment (including the modifications), the inkjet printing apparatus 10 using an aqueous ink is adopted. However, the present invention is not limited thereto, and an inkjet printing apparatus using UV ink (ultraviolet curing ink) such as an inkjet printing apparatus for label printing may be adopted. In this case, an ultraviolet irradiation mechanism for curing the UV ink on the printing paper 5 by ultraviolet irradiation is provided inside the printing mechanism 201 (see FIG. 2) instead of the drying mechanism 206.

Note that the step of correcting the landing position deviation of the nozzle for which the landing position deviation is confirmed may be performed based on the landing position deviation amount calculated in the above embodiment (including the modifications).

Note that this application claims priority to Japanese Patent Application No. 2024-013200 titled “LANDING POSITION DEVIATION AMOUNT DETECTION METHOD, PRINTING APPARATUS, AND LANDING POSITION DEVIATION AMOUNT DETECTION PROGRAM” filed on Jan. 31, 2024, the content of which is incorporated herein by reference.

What is claimed is:

1. A landing position deviation amount detection method of detecting a landing position deviation amount of ink in a printing apparatus including a plurality of nozzles configured to eject ink onto a print medium conveyed in a first direction, the landing position deviation amount detection method comprising:
printing, by the printing apparatus, an inspection chart including M-stage inspection patterns corresponding one-to-one to M groups obtained by grouping the plurality of nozzles, where M is an integer of 2 or more;
imaging the inspection chart;
obtaining a reference position with taking each of the plurality of nozzles as a focused nozzle, the reference position being a position at which ink ejected from the focused nozzle is assumed to land on the print medium;
obtaining an actual landing position that is a position at which ink ejected from the focused nozzle is actually landed on the print medium, based on a captured image obtained in the imaging the inspection chart;
obtaining a first differential amount that is a difference between the actual landing position and the reference position;
obtaining a moving average that is an average of the first differential amounts of two or more nozzles that belong to a group same as the focused nozzle and are to land ink at a position within a predetermined distance in a second direction orthogonal to the first direction from a position at which the focused nozzle is to land ink;
obtaining a second differential amount that is a difference between the difference between the actual landing position and the reference position and the moving average;
obtaining an average second differential amount that is an average of the second differential amounts of two or more nozzles that belong to a group different from the focused nozzle and are associated with the focused nozzle in advance; and
obtaining a landing position deviation amount that is a difference between the second differential amount and the average second differential amount.

2. The landing position deviation amount detection method according to claim 1, wherein in the obtaining the second differential amount, the second differential amount is obtained by calculating a difference between the first differential amount and the moving average.

3. The landing position deviation amount detection method according to claim 1, wherein in the obtaining the second differential amount, a sum of the reference position and the moving average is obtained as an ideal landing position, and the second differential amount is obtained by calculating a difference between the actual landing position and the ideal landing position.

4. The landing position deviation amount detection method according to claim 1, wherein regarding the obtaining the average second differential amount, the two or more nozzles associated with the focused nozzle in advance include nozzles belonging to each of all groups different from the group to which the focused nozzle belongs.

5. The landing position deviation amount detection method according to claim 1, wherein regarding the obtaining the average second differential amount, the two or more nozzles associated with the focused nozzle in advance include a predetermined number of nozzles that belong to each of two or more groups different from the group to which the focused nozzle belongs and are to land ink at positions close to a position where the focused nozzle should land ink in the second direction.

6. The landing position deviation amount detection method according to claim 1, wherein
in the obtaining the reference position,
a nozzle pitch that is a distance between two adjacent nozzles in the second direction is obtained based on positions of two position marks included in the captured image and a number of nozzles that should land ink in a region corresponding to between the two position marks, and
the reference position for each nozzle is obtained using the nozzle pitch.

7. The landing position deviation amount detection method according to claim 1, wherein
the obtaining the actual landing position includes:
dividing the captured image into K images in the first direction such that each of divided images corresponds to one nozzle in the first direction with K being an integer of 2 or more;
calculating an average value of data of a plurality of pixels included in the first direction for each of K divided images obtained in the dividing the captured image into K images; and
specifying the actual landing position for each nozzle based on the average value.

8. The landing position deviation amount detection method according to claim 1, wherein each of the M-stage inspection patterns includes a plurality of linear patterns that extend in the first direction and should be arranged at equal intervals in the second direction.

9. A printing apparatus comprising:
a plurality of nozzles configured to eject ink onto a print medium conveyed in a first direction;
an imaging device configured to image a print image; and
a controller configured to control ejection of ink from the plurality of nozzles and imaging of the print image by the imaging device,
the controller executing:
an inspection chart printing process of controlling the ejection of ink from the plurality of nozzles so that an inspection chart including M-stage inspection patterns corresponding one-to-one to M groups obtained by grouping the plurality of nozzles is printed, where M is an integer of 2 or more;
an inspection chart imaging process of causing the imaging device to image the inspection chart printed by the inspection chart printing process;
a reference position calculation process of obtaining, with taking each of the plurality of nozzles as a focused nozzle, a position at which ink ejected from the focused nozzle is assumed to land on the print medium as a reference position;
an actual landing position calculation process of obtaining a position at which ink ejected from the focused nozzle is actually landed on the print medium as an actual landing position, based on a captured image obtained by the inspection chart imaging process;
a first differential amount calculation process of obtaining a difference between the actual landing position and the reference position as a first differential amount;
a moving average calculation process of obtaining an average of the first differential amounts of two or more nozzles that belong to a group same as the focused nozzle and are to land ink at a position within a predetermined distance in a second direction orthogonal to the first direction from a position at which the focused nozzle is to land ink, as a moving average corresponding to the focused nozzle;
a second differential amount calculation process of obtaining a difference between the difference between the actual landing position and the reference position and the moving average, as a second differential amount;
an average second differential amount calculation process of obtaining an average of the second differential amounts of two or more nozzles that belong to a group different from the focused nozzle and are associated with the focused nozzle in advance, as an average second differential amount corresponding to the focused nozzle; and
a landing position deviation amount calculation process of obtaining a difference between the second differential amount and the average second differential amount, as a landing position deviation amount.

10. A non-transitory computer-readable recording medium recording a landing position deviation amount detection program for detecting a landing position deviation amount of ink in a printing apparatus including a plurality of nozzles configured to eject ink onto a print medium conveyed in a first direction and an imaging device configured to image a print image,
the landing position deviation amount detection program causing a computer included in the printing apparatus to execute:
controlling ejection of ink from the plurality of nozzles so that an inspection chart including M-stage inspection patterns corresponding one-to-one to M groups obtained by grouping the plurality of nozzles is printed, where M is an integer of 2 or more;
causing the imaging device to image the inspection chart so as to obtain a captured image of the inspection chart;
obtaining a reference position with taking each of the plurality of nozzles as a focused nozzle, the reference position being a position at which ink ejected from the focused nozzle is assumed to land on the print medium;
obtaining an actual landing position that is a position at which ink ejected from the focused nozzle is actually landed on the print medium, based on the captured image;
obtaining a first differential amount that is a difference between the actual landing position and the reference position;
obtaining a moving average that is an average of the first differential amounts of two or more nozzles that belong to a group same as the focused nozzle and are to land ink at a position within a predetermined distance in a second direction orthogonal to the first direction from a position at which the focused nozzle is to land ink;
obtaining a second differential amount that is a difference between the difference between the actual landing position and the reference position and the moving average;
obtaining an average second differential amount that is an average of the second differential amounts of two or more nozzles that belong to a group different from the focused nozzle and are associated with the focused nozzle in advance; and
obtaining a landing position deviation amount that is a difference between the second differential amount and the average second differential amount.
